(19) United States
(12) Patent Application Publication
(10) Pub. No.: US 2021/0389523 A1
(43) Pub. Date: Dec. 16, 2021

(54) Manufacturing Method of Spot-Size Converter and Spot-Size Converter

(71) Applicant: Nippon Telegraph and Telephone Corporation, Tokyo (JP)

(72) Inventors: Yuta Ueda, Musashino-shi, Tokyo (JP); Nobuhiro Nunoya, Musashino-shi, Tokyo (JP)

(21) Appl. No.: 17/283,831

(22) PCT Filed: Oct. 29, 2019
(86) PCT No.: PCT/JP2019/042301

§ 371 Date: Apr. 8, 2021

(30) Foreign Application Priority Data
Nov. 1, 2018 (JP) 2018-206766

(51) Int. Cl. G02B 6/136; G02B 6/14

(52) U.S. Cl. CPC G02B 6/136; G02B 6/14

(57) ABSTRACT

A method for manufacturing a spot-size converter includes: a material film etching step of sequentially forming, on a laminated substrate formed by sequentially laminating a core layer and two or more material film layers on a substrate, a plurality of mask patterns whose openings decrease in size, on the side of the two or more material film layers, and etching the two or more material film layers so as to have a step-like shape by sequentially etching the two or more material film layers from an outermost layer thereof according to the plurality of mask patterns; and a core layer etching step of forming a mask pattern for a core, which overlaps the openings of all of the plurality of mask patterns whose openings decrease in size, and has an opening with the largest area, on the side of the two or more material film layers, and forming the core layer by performing dry etching.

### TECHNICAL FIELD

The present invention relates to a method for manufacturing an optical device, and more specifically relates to a method for manufacturing a spot-size converter (SSC) that can control the spread of the electromagnetic field distribution of light in an optical waveguide.

### BACKGROUND ART

In an optical device such as a semiconductor laser or the like, an optical circuit is often formed by employing an optical waveguide structure. The mode electromagnetic field distribution, i.e. mode distribution, of light propagating in an optical waveguide is determined by the material of the optical waveguide and the structure of the waveguide. The spread of the mode distribution may be referred to as a spot size, and a smaller spot size is preferable in many cases. For example, if the spot size is small, i.e. if the power density of the light guided in the waveguide is high, the interaction between the light and the waveguide material is strong. Therefore, when the power consumption of an optical control device such as a laser or a modulator is to be reduced, it is important that the waveguide has a small spot size.

In addition, the minimum bending radius of the bending waveguide, which is often a limitation factor on the device size, is generally small when the light is strongly confined in the waveguide, and therefore a waveguide with a small spot size is often preferable.

However, conversely, a small spot size may cause problems. One of them is a problem regarding coupling with an external optical system at an input/output end face of an optical device. When the spot size is small, the spread angle of light emitted from the device to the free space is large due to the Fourier transform. If the divergence angle of the light distribution, i.e. the divergence angle of the far-field pattern (FFP) is large in the free space, there is a problem in that the aperture, i.e. the size, of the lens used to form optical coupling of the optical device with another part such as an optical fiber is large. The size of the lens is often a limitation factor when the overall size of the optical module is to be reduced.

In addition, if the spot size is small, there also is a problem in that the mounting tolerance is inherently small in a lens mounting step performed to form optical coupling of the lens with an external part.

The above problem applies to the case of emission of light from an optical device, and the same problem occurs when light is incident on the optical device because generally optical systems constituted by passive elements have reciprocity.

Therefore, it is preferable that the spot size is small in the waveguide in the device and large at the end face of the waveguide. In addition to optical coupling with an external part, there are functions that can be realized on an optical device due to such a large spot size. To realize such functions, an SSC is employed as a structure for converting the spot size at a particular position in the same optical device.

A typical example of a method for forming an SSC in an optical waveguide is to locally modify a core layer that guides light. For example, NPL 1 is a report on an SSC in a laser device that employs a compound semiconductor, in which an SSC is formed by only growing the core material of the end face of the waveguide to be thin, using a semiconductor regrowth technique.

### CITATION LIST

### Non Patent Literature

[NPL 1] Yasumasa Suzaki, Ryuzu Iga, Kenji Kishi, Yoshihiro Kawaguchi, Shin-ichi Matsumoto, Minoru Okamoto, and Mitsuo Yamamoto “Temperature- and Polarization-Insensitive Responsivity of a 1.3 μm Optical Transceiver Diode with an Integrated Spot-Size Converter”, IEEE J. Quantum Electron., vol. 34, no. 4, pp. 686-690, 1998.

### SUMMARY OF THE INVENTION

### Technical Problem

A method using a thin film formation technique as can be seen in NPL 1 is advantageous in that the core layer thickness can be realized with layer forming accuracy (nm order). However, when a three-dimensional structure is to be formed using thin film formation, there is a problem in that the processing costs are generally high because it is necessary to stabilize the formation conditions, and it is necessary to perform special wafer processing before performing thin film formation (methods using a selective growth mask as in NPL 1 requires that a dielectric pattern be formed on a wafer), for example.

The present invention has been made in view of the foregoing conventional problems, and an object to be solved by the present invention is to provide a method for manufacturing a spot-size converter (SSC), which can be realized as a simple manufacturing method.

### Means for Solving the Problem

To solve the above-described problem, a method for manufacturing a spot-size converter according to one embodiment includes: a material film etching step of sequentially forming, on a laminated substrate formed by sequentially laminating a core layer and two or more material film layers on a substrate, a plurality of mask patterns whose respective openings decrease in size one after another, on the side of the two or more material film layers, and etching the two or more material film layers so as to have a step-like shape by sequentially etching the two or more material film layers from an outermost layer thereof according to the plurality of mask patterns; and a core layer etching step of forming a mask pattern for a core, which overlaps the openings of all of the plurality of mask patterns whose respective openings decrease in size one after another, and has an opening with the largest area, on the side of the two or more material film layers, and forming the core layer that has a step in a thickness direction of the substrate by performing dry etching according to the mask pattern for a core.

A method for manufacturing a spot-size converter according to another embodiment includes: a physical property gradient layer etching step of forming a first mask pattern on a laminated substrate formed by laminating, on a substrate, a core layer and a physical property gradient layer whose physical properties vary in component ratio in a thickness direction of the substrate, on the physical property gradient layer side, and performing wet etching on the physical property gradient layer according to the first mask pattern so that an inclined surface that is inclined in the thickness direction of the substrate is formed under the first mask pattern; and a core layer etching step of forming a mask pattern for a core, which overlaps a pattern defined by an outline of an area that has been subjected to etching, of the physical property gradient layer, and has an opening with a larger area, on the physical property gradient layer side, and forming a core layer that has an inclined surface that is inclined in the thickness direction of the substrate by performing dry etching according to the mask pattern for a core.

### BRIEF DESCRIPTION OF DRAWINGS

FIG. 1 is a diagram showing a configuration of a laminated body 10 that has a step-forming multilayer film 20.

FIG. 2 is a diagram showing a state in which a mask 50 that has a rectangular mask pattern is laminated on the laminated body 10.

FIG. 3 is a diagram showing the laminated body 10 that has been etched through a first etching step.

FIG. 4 is a diagram showing the laminated body 10 on which the mask 50 to be used in a second etching step has been formed.

FIG. 5 is a diagram showing the laminated body 10 that has been etched through the second etching step.

FIG. 6 is a diagram showing the laminated body 10 on which the mask 50 to be used in a third etching step has been formed.

FIG. 7 is a diagram showing the laminated body 10 that has been etched through the third etching step.

FIG. 8 is a diagram showing the laminated body 10 on which a clad material has been grown on a core layer 2-side surface.

FIG. 9 is a diagram showing the laminated body 10 that has a waveguide structure 30 that includes a core layer 2 whose thickness has been changed so as to have a step-like shape.

FIG. 10 is a diagram showing results of calculation of an angle of a full width at half maximum of an FFP (far-field pattern) emitted from an end face of an SSC obtained through a manufacturing method according to a first embodiment.

FIG. 11 is a diagram showing a configuration of a laminated body 11 that has a physical property gradient layer 21.

FIG. 12 is a diagram showing the laminated body 11 in which the physical property gradient layer 21 has been etched using the mask 50.

FIG. 13 is a diagram showing the laminated body 11 in which the core layer 2 has been etched using another mask 50.

FIG. 14 is a diagram illustrating a method for manufacturing a spot-size converter according to a third embodiment.

FIG. 15 is a diagram illustrating the method for manufacturing a spot-size converter according to the third embodiment.

FIG. 16 is a diagram illustrating the method for manufacturing a spot-size converter according to a modification of the third embodiment.

FIG. 17 is a diagram illustrating a method for manufacturing a spot-size converter according to the modification of the third embodiment.

FIG. 18 is a diagram illustrating the method for manufacturing a spot-size converter according to the modification of the third embodiment.

FIG. 19 is a diagram illustrating the method for manufacturing a spot-size converter according to the modification of the third embodiment.

### DESCRIPTION OF EMBODIMENTS

Hereinafter, embodiments of the present invention will be described in detail.

According to the method for manufacturing a spot-size converter (SSC) disclosed in the present embodiment, on a laminated substrate formed by sequentially laminating a core layer and two or more material film layers on a substrate, a plurality of mask patterns whose respective openings decrease in size one after another are sequentially formed on the side of the two or more material film layers. Thereafter, the two or more material film layers are sequentially etched from the outermost layer according to the plurality of mask patterns in a material film etching step, and a mask pattern for the core, which overlaps the openings of all of the plurality of mask patterns whose respective openings decrease in size one after another, and has an opening with the largest area, is formed on the side of the two or more material film layers. The method also includes a core layer etching step in which dry etching is performed according to the mask pattern for the core to form a core layer that has a step in the thickness direction of the substrate.

According to this manufacturing method, it is possible to manufacture an SSC with the same processing accuracy as the accuracy of thin film formation, through a step that does not require stabilization of other special processing conditions.

In addition, in the above-described manufacturing method, it is also possible to use a laminated substrate that includes, instead of the two or more material film layers, a physical property gradient layer whose physical properties vary in component ratio in the thickness direction of the substrate. Specifically, on the laminated substrate, a first mask pattern is formed on the physical property gradient layer side, and wet etching is performed on the physical property gradient layer according to the first mask pattern so that an inclined surface that is inclined in the thickness direction of the substrate is formed under the first mask pattern. It is possible to adopt a manufacturing method that also includes a core layer etching step in which a mask pattern for a core, which overlaps a pattern defined by the outline of the area that has been subjected to wet etching, of the physical property gradient layer, and has an opening with a larger area, is formed on the physical property gradient layer side, and a core layer that has an inclined surface that is inclined in the thickness direction of the substrate is formed by performing dry etching according to the mask pattern for a core.

### First Embodiment

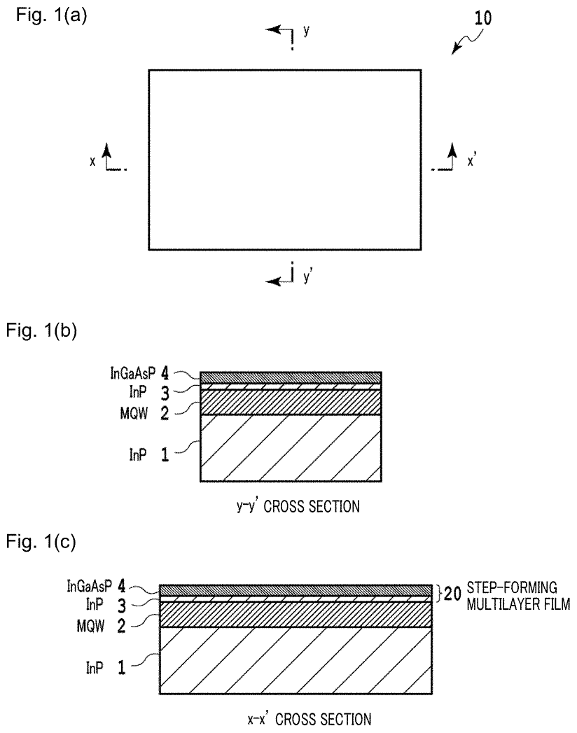

FIGS. 1 to 9 are diagrams illustrating the steps of a method for manufacturing a spot-size converter according to a first embodiment. Note that, in FIGS. 1 to 9, (a) is a plan view of a laminated body 10 seen from the side opposite to a substrate 1, (b) is an end face diagram of a cross section taken along y-y′, and (c) is an end face diagram of a cross section taken along x-x′. In the first embodiment, an SSC formed using a laminated body 10 that includes a step-forming multilayer film 20 on a core layer 2 is manufactured using an InP-based material.

First, as shown in FIG. 1, a multi-quantum well (MQW) that is made of a III-V group-based material, namely InAlGaAs/InAlAs, and has a photoluminescence wavelength of 1400 nm, is formed on a substrate 1 that is made of InP, as a core layer 2, and furthermore, a multilayer film 20 that has a total thickness of 300 nm and is constituted by two types of material layers that each have a thickness of 150 nm, namely a layer 3 that is made of InP and a layer 4 that is made of InGaAsP, is laminated thereon as a step-forming multilayer film 20, and thus the laminated body 10 is formed. Note that the thickness of the core layer 2 is 500 nm.

The laminated body 10 may be made of any material other than InP-based material, such as Si or glass, as long as a waveguide can be formed through etching.

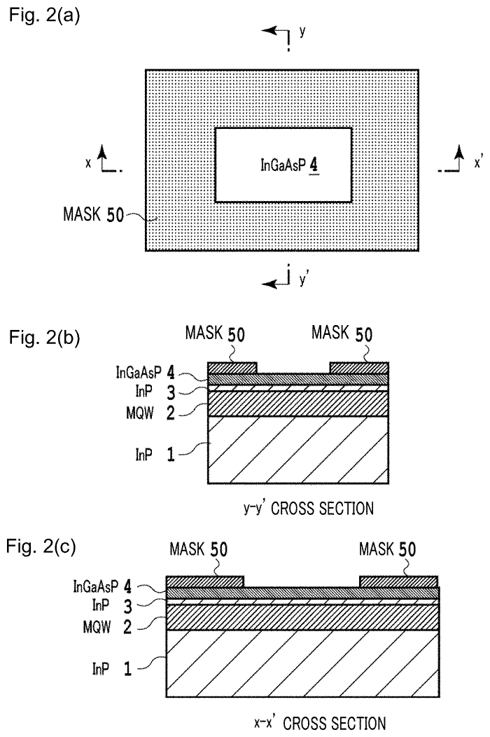

An opening mask pattern, which is shown in FIG. 2, is formed on such a laminated body 10 by using an appropriate photolithography step, and a wet etching step (a first etching step) is performed on the laminated body 10 with the mask pattern shown in FIG. 2, using a so-called piranha solution, in which a sulfuric acid, a hydrogen peroxide solution, and pure water are mixed in appropriate proportions. This piranha solution is an etching solution formulated so as to be able to remove InGaAsP, which is the constituent material of the uppermost layer 4, but unable to remove InP, which is the constituent material of the layer 3 below the uppermost layer 4.

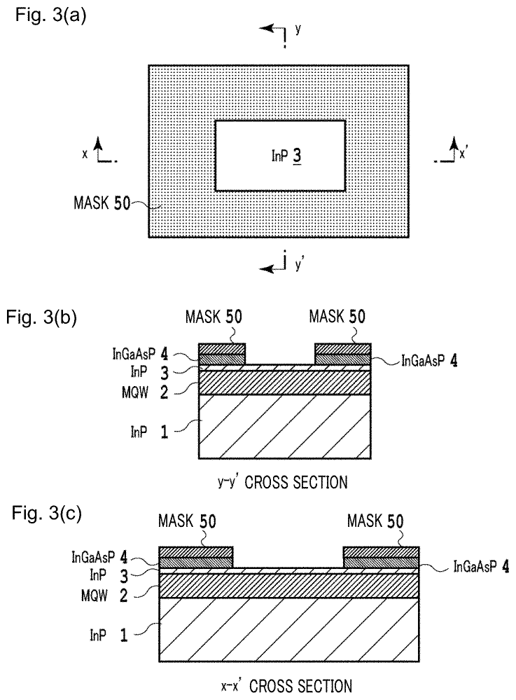

In the first etching step, InGaAsP of the uppermost layer 4 of the laminated body 10 is etched by the piranha solution, whereas InP of the layer 3 below the uppermost layer 4 is not etched by the piranha solution. As a result, the laminated body 10 has the shape shown in FIG. 3.

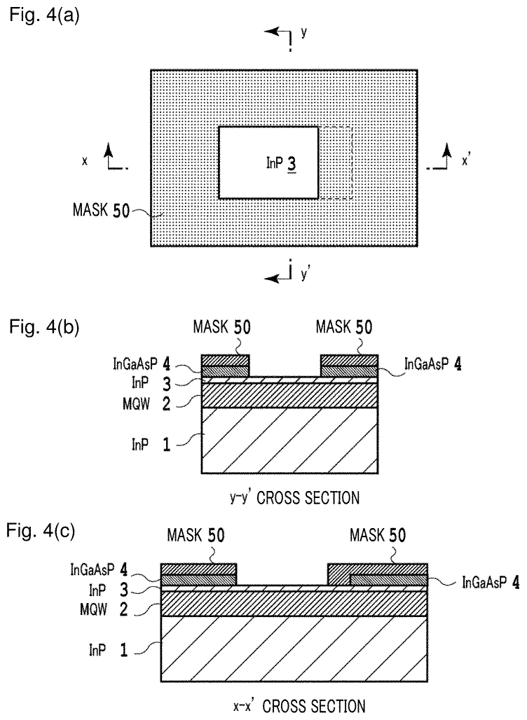

The opening mask shown in FIG. 4 is formed using a photolithography step again, and a wet etching step (a second etching step) is performed on the laminated body 10 that has the opening mask shown in FIG. 4, using a mixed solution of a hydrochloric acid and a phosphoric acid. This etching solution is formulated so as to be able to remove the InP layer 3, but unable to remove InAlGaAs/InAlAs, i.e. the core layer 2.

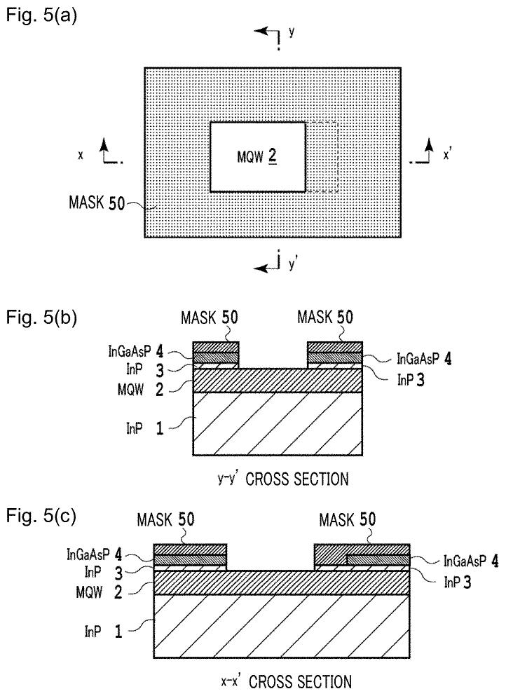

In the second etching step, the InP layer 3 immediately above the core layer 2 is etched, whereas the core layer 2 is not etched. As a result, the laminated body 10 has the shape shown in FIG. 5.

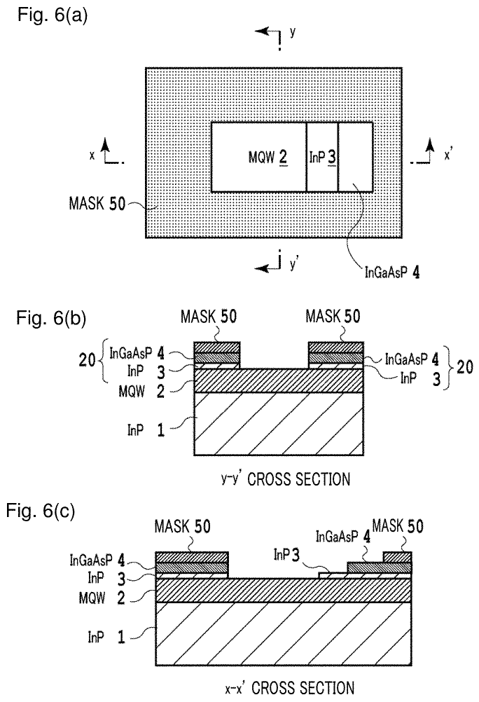

The opening mask pattern shown in FIG. 6 is formed on the laminated body 10 shown in FIG. 5 thus obtained, using an appropriate photolithography step again, and an etching step (a third etching step) is performed on the laminated body 10 that has the opening mask pattern shown in FIG. 6, using a dry etching apparatus that can act to process all of the InGaAsP layer 4, the InP layer 3, and the MQW 2 made of InAlGaAs/InAlAs. This dry etching is realized using chlorine-based plasma, for example.

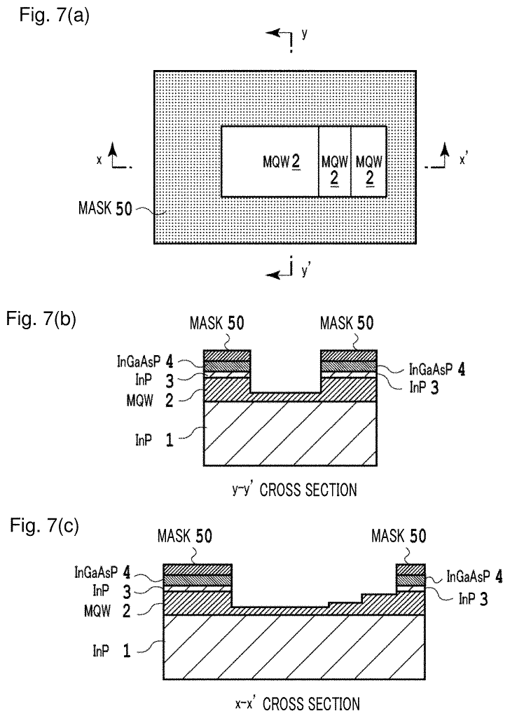

Through the third etching step, the core layer 2 is processed into a step-like shape as shown in FIG. 7, reflecting the step-like opening pattern of the step-forming multilayer film 20 shown in FIG. 6.

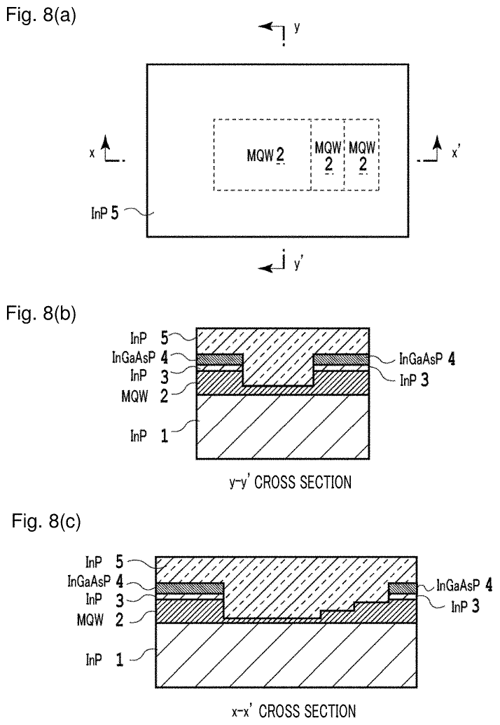

Thereafter, as shown in FIG. 8, the InP material is formed as a clad material 5 on the surface where the core layer 2 of the laminated body 10 is processed so as to have a step-like shape, using a semiconductor growth technology.

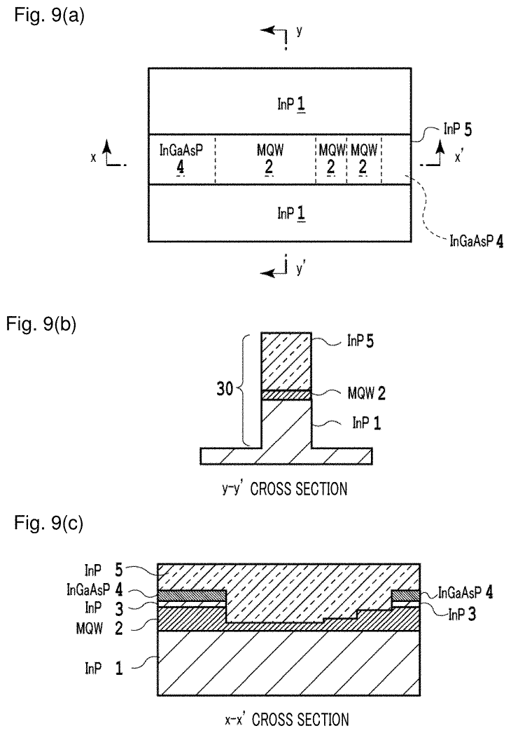

Then, by forming the InP material using an appropriate photolithography process and a semiconductor etching process as shown in FIG. 9, it is possible to obtain a waveguide structure 30 that includes the core layer 2 whose thickness has been changed so as to have a step-like shape, in the laminated body 10.

As shown in FIG. 9, if the waveguide structure 30 is cut along the broken line at the boundary between the region covered with the InGaAsP layer 4 and the region where the core (MQW) layer 2 is exposed, so as to show the end face of the waveguide, the core layer 2 at this portion is thinner than the original core layer 2, and the spot size of light guided here is expected to be different from the spot size of light guided in the original core layer 2.

In the waveguide structure 30 obtained in this embodiment, the etching rate for each material, for example, of the above-described dry etching process is fixed if the dry etching conditions are fixed, and the thickness and the type of the step-forming multilayer film 20 can be accurately controlled using a thin film formation technique (the epitaxial growth technique in this embodiment). Therefore, the changes in the thickness of the core layer 2 is almost determined by the accuracy of the thin film formation technique.

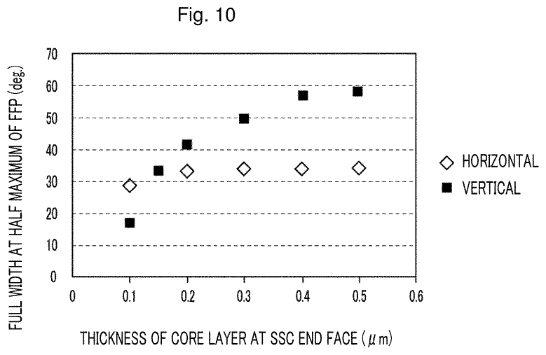

Here, the results of calculation of the FFP of the SSC manufactured according to the manufacturing method according to the present embodiment are studied. FIG. 10 is a diagram showing the results of calculation of the angle of the full width at half maximum of the FFP (far-field pattern) emitted from an end face of the SSC obtained through the manufacturing method according to the present embodiment. Light having a wavelength of 1550 nm was used for the calculation. The width of the waveguide structure 30 (see FIG. 9) used for this calculation was fixed to 3 μm, and SSCs manufactured through the above-described steps were used, which were manufactured under a plurality of conditions with different thicknesses of the core layer 2 (see FIG. 9) at the end face thereof.

It can be seen from FIG. 10 that the FFP angle in the vertical direction of the substrate 1 decreases as the thickness of the MQW core layer 2 (see FIG. 9) at the SSC end face is made thinner than 500 nm. In other words, it can be seen that the spread of light emitted from the obtained SSC decreases. In view of the FFP in the horizontal direction of the substrate 1 as well, the core layer 2 at the SSC end face looks like a perfect circle as an FFP, at about 150 nm.

Therefore, it can be seen that the SSC manufactured through the manufacturing method according to the present embodiment can have a thin core layer at the SSC end face, and can satisfactorily function as an SSC.

With the SSC manufacturing method according to the present embodiment, a high-performance SSC can be manufactured through simple manufacturing procedures, a coupling loss of general optical devices can be improved, and thus the SSC manufacturing method according to the present embodiment contributes to further spread of optical communication.

In the present embodiment, the constituent materials of the uppermost layer 4 and the layer 3 thereunder of the laminated body 10 are InGaAsP and InP, respectively, and the etching solution used in the first etching step is a piranha solution that can remove InGaAsP but cannot remove InP. However, the present invention is not limited in this way. The present invention can be realized in the same manner as in the present embodiment by forming the uppermost layer 4 and the layer 3 thereunder from different materials, and using an etching solution that have different effects on these materials (an etching solution that removes the material of one of the two layers 3 and 4, but does not remove the material of the other layer).

### Second Embodiment

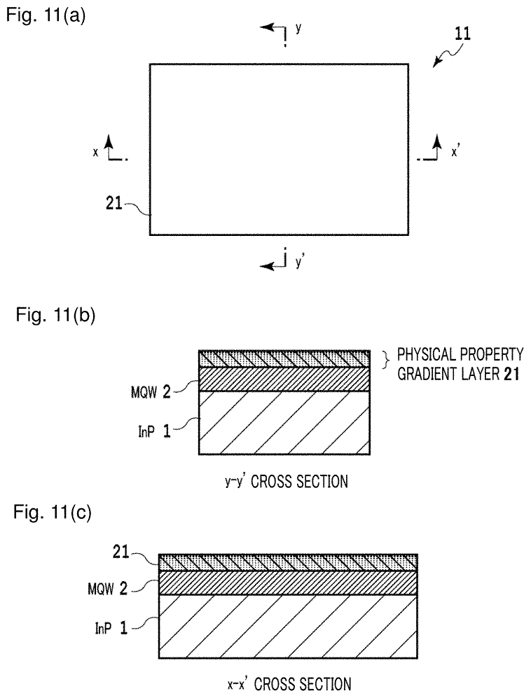

FIGS. 11 to 13 are diagrams illustrating the steps of a method for manufacturing a spot-size converter according to a second embodiment. In the first embodiment, the core layer 2 is processed so as to have a step-like shape. However, large steps may be a cause of a scattering loss of guided light. Therefore, in the manufacturing method according to the present embodiment, a laminated body 11 that has a physical property gradient layer 21 whose physical property values continuously change is adopted instead of the laminated body in the first embodiment, which includes the step-forming multilayer film 20 constituted by two kinds of materials, namely InP and InGaAsP. Regarding the manufacturing method according to the second embodiment, only differences from the manufacturing method according to the first embodiment will be described.

In the manufacturing method according to the second embodiment, the laminated body 11 is used as shown in FIG. 11, which is provided with the physical property gradient layer 21 whose physical property values continuously change, instead of the step-forming multilayer film 20 in the first embodiment constituted by two kinds of materials, namely InP and InGaAsP.

The physical property values of the physical property gradient layer 21, which are determined by the components of the film material are inclined with respect to the vertical direction of the substrate 1. That is to say, the physical property gradient layer 21 is constituted by a material in which the GaAs component increases from a portion that is constituted by the InP component only, as the distance from the substrate 1 increases, such that substrate matching can be achieved (which means that the band gap of InGaAsP decreases), and ultimately reaches a portion of InGaAs. Such a layer structure is adopted as a GRIN layer (grated refractive index layer) in a semiconductor laser, for example.

The piranha solution used in the first etching step in the first embodiment has almost no etching effect on InP, but has an etching effect on InGaAsP, and it is known that the etching speed increases as the GaAs component increases.

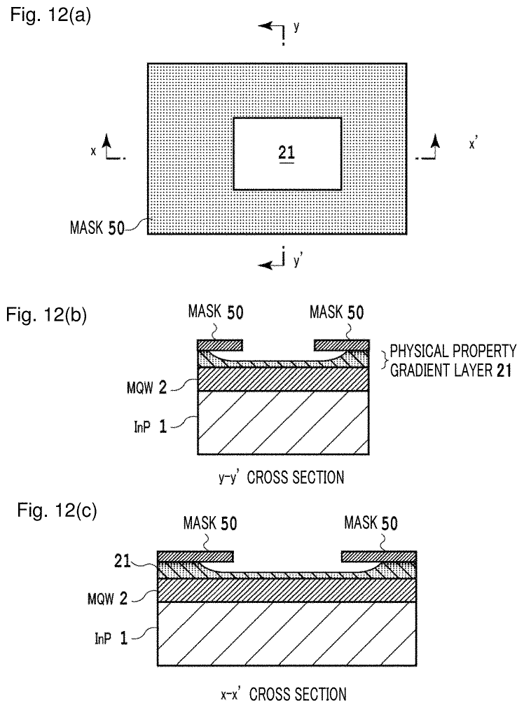

As shown in FIG. 12, after the opening mask 50 having an appropriate pattern has been formed, the laminated body 11 including the physical property gradient layer 21 is dipped in a piranha solution, and, as a result, the physical property gradient layer 21 is subjected to wet etching. Due to the inclination of the physical property values, the etching direction changes such that the component in the direction parallel to the substrate is larger than the component in the direction orthogonal to the substrate. As a result, the physical property gradient layer 21 is processed into a shape that has an inclined surface that partly lies under the mask pattern as shown in (b) and (c) in FIG. 12.

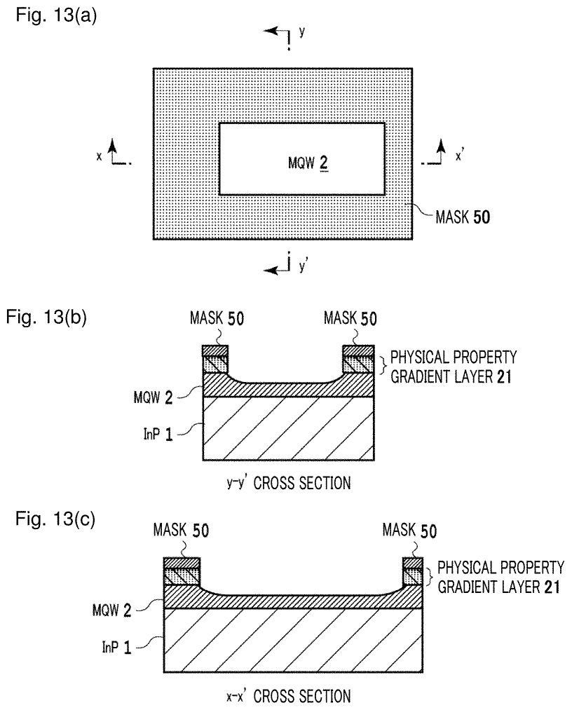

Furthermore, as shown in FIG. 13, a mask pattern is formed along the outline of the area that has been subjected to wet etching, of the physical property gradient layer 21, and the physical property gradient layer 21 and the core layer 2 are subjected to dry etching at once, as in the first embodiment. As a result, as shown in FIG. 13, the core layer 2 is processed so as to have a continuous inclined surface.

Thereafter, the clad layer is deposited according to the requirements as in the first embodiment, and the waveguide is processed. Thus, an SSC in which the core layer 2 has an inclined structure can be obtained. If necessary, by forming a cleavage along the x-x′ cross section or the y-y′ cross section, it is possible to form the core layer 2 so as to have an inclined structure inclined in one direction as in the first embodiment.

### Third Embodiment

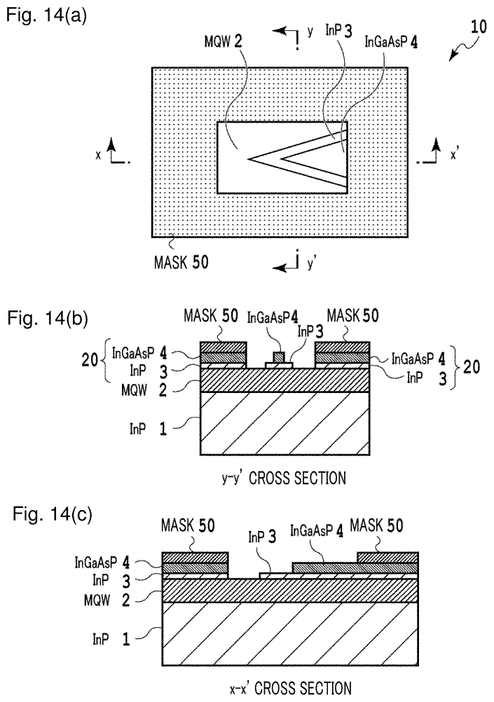

FIGS. 14 to 19 are diagrams illustrating the steps of a method for manufacturing a spot-size converter according to a third embodiment. In both the manufacturing method in the first embodiment and the manufacturing method in the second embodiment, the mask pattern has a rectangular shape in the horizontal direction of the substrate. In the present embodiment, the mask pattern is not rectangular in the horizontal direction of the substrate, but has a shape that is inclined in the horizontal direction of the substrate (not shown). In other points, the manufacturing method in the third embodiment may be the same as the manufacturing method in the first embodiment or the same as the manufacturing method in the second embodiment. Regarding the manufacturing method according to the third embodiment, only differences from the manufacturing method according to the first embodiment and the manufacturing method according to the second embodiment will be described.

The mask pattern 50 used in the first etching step and the second etching step in the first embodiment (see FIGS. 3 and 5) is formed so as to have a shape that is inclined in the horizontal direction of the substrate 1, instead of the shape that is rectangular in the horizontal direction of the substrate 1. As a result, as shown in FIG. 14, the step-forming multilayer film 20 can be formed so as to have a shape that is inclined in the horizontal direction of the substrate 1.

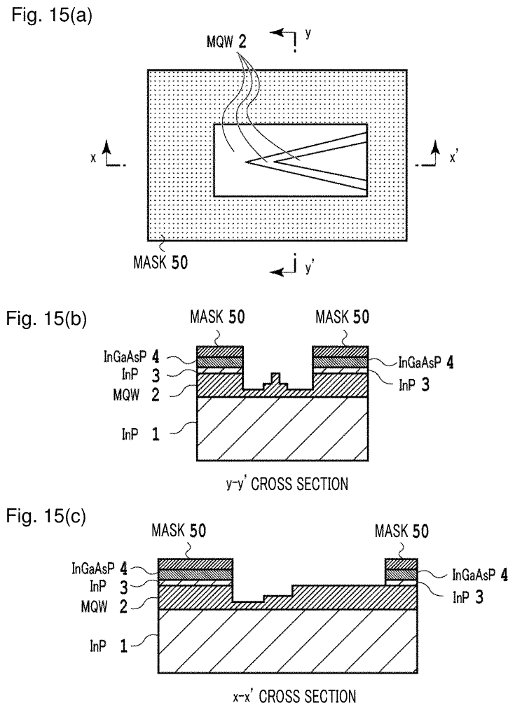

Furthermore, dry etching is performed on the laminated body 10 that includes the step-forming multilayer film 20 formed as shown in FIG. 14 using the rectangular mask pattern 50. As a result, as shown in FIG. 15, the core layer 2 has a shape that is inclined in the horizontal direction of the substrate 1. Therefore, the structure of the waveguide continuously changes for the light guided through the core layer 2, which contributes to the reduction of an excess loss.

### Modification of Third Embodiment

It is also effective in suppressing light reflected from the step-like portion of the core layer 2 manufactured using the manufacturing method according to the third embodiment. Reflected light should be sufficiently removed if the optical device that has the waveguide structure 30 is integrated in a semiconductor laser, for example.

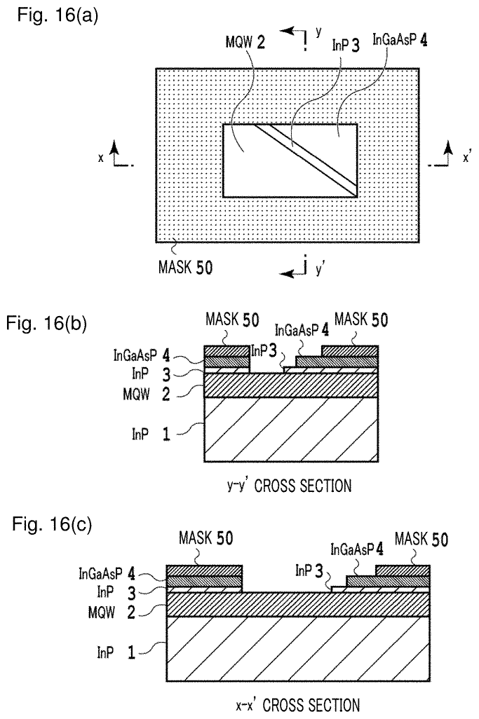

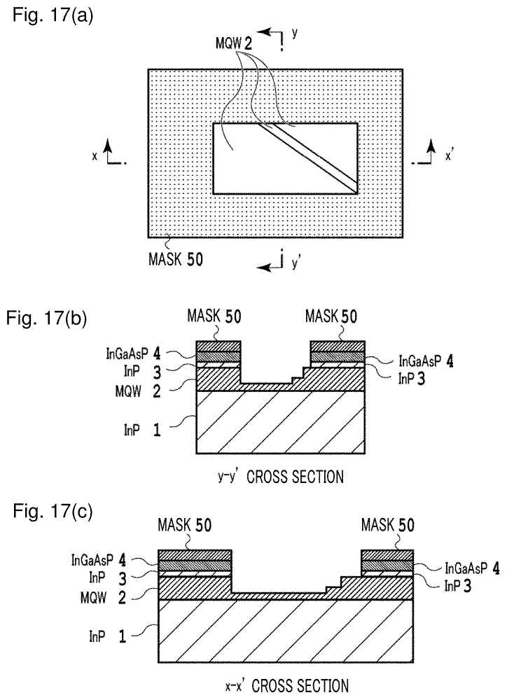

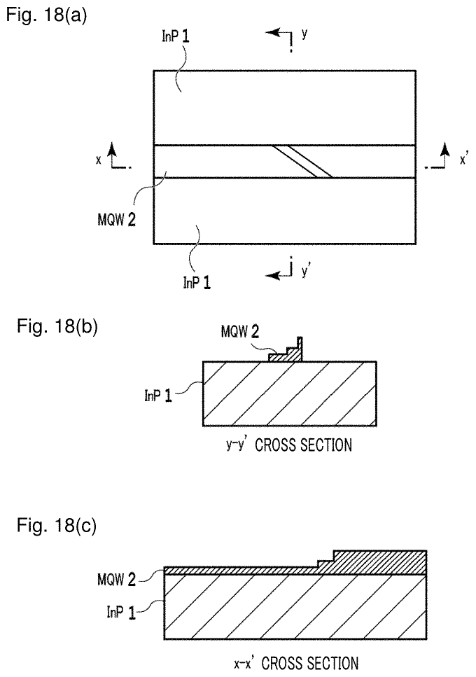

In the present embodiment, as one form of the inclined shape in the horizontal direction of the substrate 1, the step-forming multilayer film 20 of the laminated body 10 is etched into the shape shown in FIG. 16, using an opening pattern that has an outline that obliquely intersects the light wave guiding direction, and furthermore, the core layer 2 is thinned by performing dry etching using the rectangular mask 50 as shown in FIG. 17. Furthermore, as shown in FIG. 18, after the step-forming multilayer film 20 is removed so that only the core layer 2 is left, the core layer 2 is further processed so that a certain width is left.

Thereafter, Inp is grown as a clad layer (not shown) so that the core layer 2 is embedded, and thus an SSC that has a so-called embedded waveguide can be manufactured.

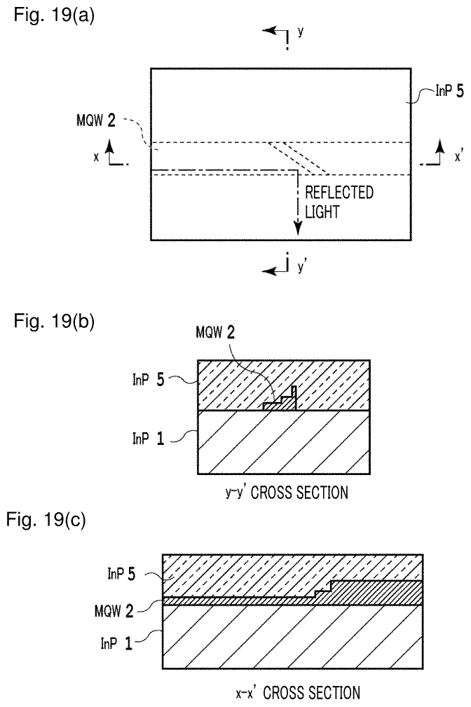

Although the power of the light guided in the core layer 2 of the SSC manufactured through the manufacturing method according to the present embodiment is partially reflected due to a discontinuity point in the waveguide, the light is reflected at a constant angle with respect to the optical axis as shown in FIG. 19 because the core layer 2 is covered with the clad layer that is composed of InP with a refractive index that is close to that of the core layer 2, and therefore, unnecessary light input to other optical components including an SSC can be reduced.

### REFERENCE SIGNS LIST

1 Substrate
2 Core layer
3 InP layer
4 InGaAsP layer
10 Laminated body
11 Laminated body
20 Step-forming multilayer film
21 Physical property gradient layer
30 Waveguide structure
50 Mask pattern

1. A method for manufacturing a spot-size converter, comprising:
a material film etching step of sequentially forming, on a laminated substrate formed by sequentially laminating a core layer and two or more material film layers on a substrate, a plurality of mask patterns whose respective openings decrease in size one after another, on the side of the two or more material film layers, and etching the two or more material film layers so as to have a step-like shape by sequentially etching the two or more material film layers from an outermost layer thereof according to the plurality of mask patterns; and
a core layer etching step of forming a mask pattern for a core, which overlaps the openings of all of the plurality of mask patterns whose respective openings decrease in size one after another, and has an opening with the largest area, on the side of the two or more material film layers, and forming the core layer that has a step in a thickness direction of the substrate by performing dry etching according to the mask pattern for a core.

2. A method for manufacturing a spot-size converter, comprising:
a physical property gradient layer etching step of forming a first mask pattern on a laminated substrate formed by laminating, on a substrate, a core layer and a physical property gradient layer whose physical properties vary in component ratio in a thickness direction of the substrate, on the physical property gradient layer side, and performing wet etching on the physical property gradient layer according to the first mask pattern so that an inclined surface that is inclined in the thickness direction of the substrate is formed under the first mask pattern; and
a core layer etching step of forming a mask pattern for a core, which overlaps a pattern defined by an outline of an area that has been subjected to etching, of the physical property gradient layer, and has an opening with a larger area, on the physical property gradient layer side, and forming a core layer that has an inclined surface that is inclined in the thickness direction of the substrate by performing dry etching according to the mask pattern for a core.

3. The method for manufacturing a spot-size converter according to claim 1, wherein the plurality of mask patterns have surfaces that are inclined in a horizontal direction of the substrate.

4. The method for manufacturing a spot-size converter according to claim 2, wherein the first mask pattern has a surface that is inclined in a horizontal direction of the substrate.

5. The method for manufacturing a spot-size converter according to claim 1, further comprising: a waveguide forming step of forming a waveguide by depositing a clad material on the core layer and removing the layers on the laminated substrate in a thickness direction of the substrate within a predetermined width in a plane direction of the substrate.

6. A spot-size converter comprising a core layer and a clad layer sequentially laminated on a substrate, wherein the core layer has a surface that is inclined relative to a light wave guiding direction in a horizontal direction of the substrate.

7. The method for manufacturing a spot-size converter according to claim 2, further comprising: a waveguide forming step of forming a waveguide by depositing a clad material on the core layer and removing the layers on the laminated substrate in a thickness direction of the substrate within a predetermined width in a plane direction of the substrate.

8. The method for manufacturing a spot-size converter according to claim 3, further comprising: a waveguide forming step of forming a waveguide by depositing a clad material on the core layer and removing the layers on the laminated substrate in a thickness direction of the substrate within a predetermined width in a plane direction of the substrate.

9. The method for manufacturing a spot-size converter according to claim 4, further comprising: a waveguide forming step of forming a waveguide by depositing a clad material on the core layer and removing the layers on the laminated substrate in a thickness direction of the substrate within a predetermined width in a plane direction of the substrate.
